(19) United States
(12) Patent Application Publication
(10) Pub. No.: US 2019/0285163 A1
(43) Pub. Date: Sep. 19, 2019

(54) VEHICLE PROPULSION SYSTEM

(71) Applicant: GM GLOBAL TECHNOLOGY OPERATIONS LLC, DETROIT, MI (US)

(72) Inventors: William L. Cousins, Ortonville, MI (US); Mohammad Galab, Krishna District (IN); Richard Nietz, Shelby Township, MI (US)

(21) Appl. No.: 15/922,248

(22) Filed: Mar. 15, 2018

(51) Int. Cl. F16H 57/04

(52) U.S. Cl. CPC F16H 57/0423; F16H 57/0457; F16H 57/0404

(57) ABSTRACT

A vehicle propulsion system includes a manual transmission with a transmission housing, a pump inlet positioned near an inside bottom surface of the transmission housing, and a baffle positioned adjacent the pump inlet for directing lubricating fluid in the transmission toward the pump inlet.

### FIELD

The present disclosure relates to a vehicle propulsion system.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Transmissions include many rotating components that require lubricants for proper performance and longevity. “Splash” lubrication systems rely upon the displacement of splashed oil throughout the transmission to necessary components without the aid of a pump. Under most conditions, the lubricating fluid settles under the force of gravity to toward the bottom of the transmission housing and those gears which are positioned toward the bottom of the transmission may rotate through this fluid and displace the fluid throughout the remaining components thereby lubricating them by “splashing” that fluid to them.

As vehicle propulsion systems increase in complexity, the management of heat throughout those systems becomes increasingly important. As a result, some splash lubricating manual transmission may include a pump inlet which may route the lubricating fluid to other components in the vehicle propulsion system. For example, a splash lubricating manual transmission may include a pump inlet at the lower end of the transmission housing and the pump may then route the fluid to a heat exchanger located elsewhere in the propulsion system. In this manner, heat may then transferred between the transmission and the heat exchanger which may improve efficiency, performance, fuel economy, emissions and the like.

At high vehicle speeds, the gears in the manual transmission may be rotating so rapidly that the lubricating fluid no longer has the opportunity to collect at the bottom of the transmission housing solely in reaction to the force of gravity. Rather, the cavitation and splashing of the lubricating fluid throughout the transmission may result in starvation of oil at the inlet to a pump even though that inlet is positioned at the bottom of the transmission housing. The high speed rotation of the gears may result in fluid cavitation and/or aeration that may lower the mass of fluid for any given amount of volume that is available to the pump inlet and, as a result, an overall reduction in the heat capacity of the volume displaced by the pump. This may result in a significant decrease in the ability of the thermal transfer system to transfer heat between the transmission and other components in the vehicle propulsion system. In some conditions, this may result in an undesirable increase in the temperature of the transmission and/or other potential problems.

Some conventional vehicle transmissions, especially, automatic transmissions may overcome this problem by incorporating a sump into the transmission housing which with an increase in the volume of fluid throughout the transmission provides a volume in which the fluid is able to collect, even under conditions where a high amount of cavitation and/or aeration may be occurring. However, incorporating a sump volume into a transmission housing requires additional space, material, and fluid which may adversely affect the overall vehicle performance, costs, and/or efficiency. It is desirable to provide a manual transmission which may operate at high speeds, which adequately lubricates the transmission, is properly thermally manageable and which does not require a sump and therefore avoids the costs associated with having a sump.

### SUMMARY

In an exemplary aspect, a vehicle propulsion system includes a manual transmission with a transmission housing, a pump inlet positioned near an inside bottom surface of the transmission housing, and a baffle positioned adjacent the pump inlet for directing lubricating fluid in the transmission toward the pump inlet.

In another exemplary aspect, the shape of the inside bottom surface of the transmission is substantially horizontal and flat.

In another exemplary aspect, a cross-section of the baffle is substantially L-shaped.

In another exemplary aspect, the pump inlet is positioned on an interior of the L-shaped baffle.

In another exemplary aspect, the baffle is positioned between the pump inlet and a gear of the manual transmission.

In another exemplary aspect, the corner of the L-shaped baffle points toward a gear of the manual transmission.

In another exemplary aspect, the pump inlet is substantially enclosed within the L-shaped baffle.

In another exemplary aspect, the system further includes a filter at the pump inlet.

In another exemplary aspect, the transmission housing is a non-sump transmission housing.

In another exemplary aspect, the transmission housing is sump-less.

In this manner, a manual transmission having a splash lubrication system provides an adequate supply of fluid at an inlet to a pump while obviating the need for providing a sump which would otherwise increase the weight, mass, and size of the transmission. This improves the cooling performance of the system even when the transmission is operated at high speeds. Further, this improves the ability to transfer heat between the transmission and other components with a vehicle propulsion system. Additionally, pump noise may be reduced as a result of a reduction in fluid cavitation and air entrainment within the fluid at the inlet to the pump.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view of an exemplary manual transmission 100 in accordance with the present disclosure;

FIG. 2 is a cross-sectional illustration of the manual transmission 100; and

FIG. 3 is a perspective view of selected components from the manual transmission 100.

In the drawings; reference numbers may be reused to identify similar and/or identical elements.

### DETAILED DESCRIPTION

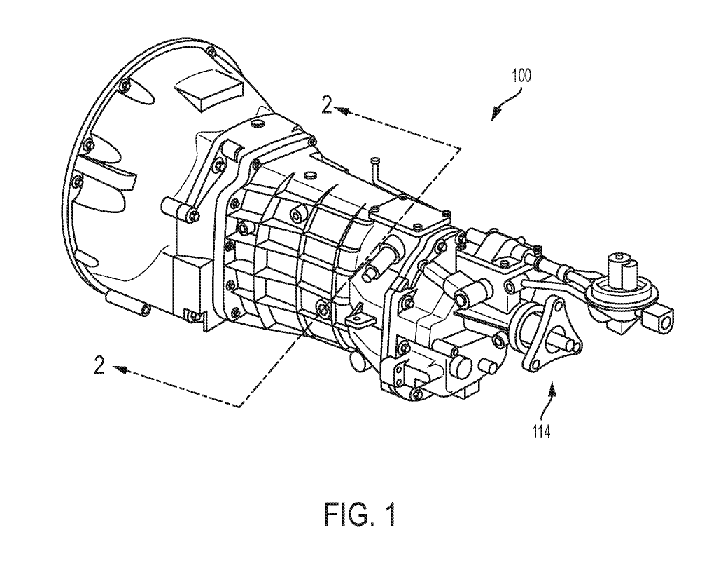

FIG. 1 is a perspective view of an exemplary manual transmission 100 in accordance with the present disclosure. The manual transmission 100 may form a portion of a vehicle propulsion system in a vehicle (not shown). As is known in the relevant art, the manual transmission 100 may include an input member (not shown), an output member 114, and a plurality of gear sets (not shown). The input member may be connected to torque producing prime mover in a vehicle such as, for example an internal combustion engine, electric motor, and the like without limitation. The manual transmission 100 may then convert the received torque to an output torque that is provided to the output member 102 which may be connected to final drive assembly connected to a drive member for propelling the vehicle.

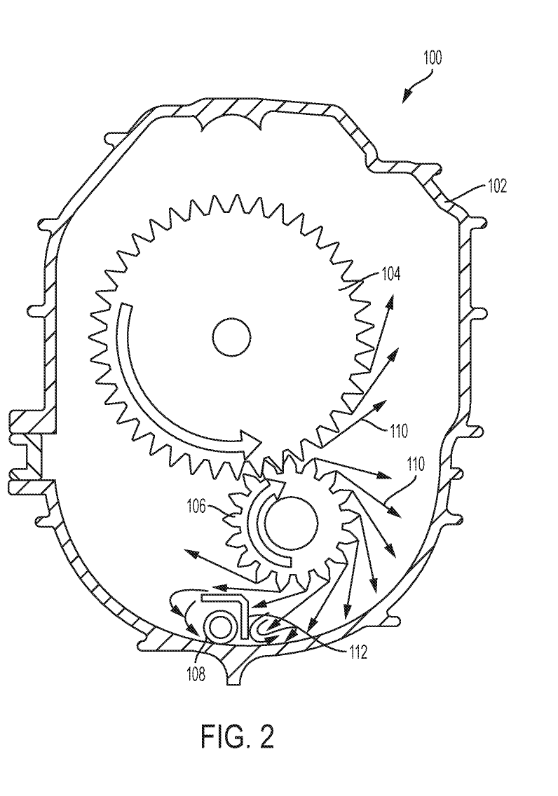

FIG. 2 is a cross-section view of the manual transmission 100 taken along lines A-A of FIG. 1. The manual transmission 100 includes a transmission housing 102 surrounding an input shaft pinion gear 104 that mates with a countershaft pinion gear 106 for transmitting torque. The transmission 100 is a splash lubrication type of transmission in which lubricating fluid is distributed throughout the components of the transmission by lubricating fluid being moved around by the motion of gears in the transmission including the countershaft pinion gear 106 and the input shaft pinion gear 104. At low speed operation, lubricating fluid tends to pool at the bottom inside surface of the transmission housing and the countershaft pinion gear 106 picks up the fluid and flings it around in the transmission housing, thereby distributing the lubricating fluid to other components. The flow of lubricating fluid being distributed from the gears 104 and 106 are illustrated generally by arrows 110.

The manual transmission 100 further includes an inlet 108 for a pump or the like, which, under most conditions, is immersed in the pool of lubricating fluid at the bottom inside surface of the transmission housing. At lower vehicle speeds, the lubricating fluid pools in the bottom inside surface of the transmission housing and the inlet 108 receives an adequate supply of lubricating fluid. However, at higher vehicle speeds, the increased rotational speed of the gears 104 and 106 results in a very high amount of cavitation and/or aeration in the fluid such that it is substantially equally dispersed within the transmission housing 102 and does not pool at the bottom inside surface of the transmission housing.

In order to provide a supply of lubricating fluid at the inlet 108, the manual transmission 100 further includes an exemplary baffle 112 which directs lubricating fluid to the inlet 108. In the exemplary embodiment illustrated in FIG. 1, the baffle 112 is L-shaped and is positioned adjacent to the inlet 108 and between the inlet 108 and the gear set (104 and 106). In particular, the L-shaped baffle 112 is oriented within the transmission 100 such that it not only resides between the inlet 108 and the gear set (104 and 106) but it also substantially encompasses the inlet 108 such that lubricating fluid being thrown off the gear set in the direction of the inlet 108 are intercepted by the baffle 112. Conventional, and/or typical baffles tend to be shaped, oriented, and positioned such that they do not intercept the flow of lubricating fluid between the gear set and the inlet. Rather, they tend to be positioned to catch and re-direct fluid which may have passed beyond the inlet and/or would not have impinged directly upon the inlet. In stark contrast, the inventors of the present disclosure discovered that contrary to the conventional thinking and designs of those of ordinary skill in the art, the supply of fluid to the inlet may be improved by positioning the baffle between the inlet and the gear set, shaping the baffle into an L-shape and orienting the L-shaped baffle such that the inlet is substantially encompassed within the baffle.

In contrast to transmissions, which may have incorporated a splash lubrication system, the inventive baffle of the present disclosure obviates the necessity of incorporating a sump into the transmission housing and the increased volume of fluid necessary for a transmission having a sump. In a transmission having a sump incorporated into the housing the sump provides a volume of space in which transmission fluid may collect through the force of gravity. The pump inlet may then be positioned in the sump such that it is immersed in fluid that collects in the sump. In such transmissions, the sump is able to overcome the problem of inlet fluid starvation even in a splash lubrication system. However, the added volume of space in the transmission housing that accommodates the presence of the sump requires an additional volume of fluid to be provided to the transmission in order for it to be effective. The present invention obviates the necessity of having a sump in the transmission and the additional volume and mass of fluid. This increases the efficiency of the overall propulsion system through a reduction in weight, mass, and space in a vehicle incorporating the transmission.

As illustrated in FIG. 2, the L-shaped baffle 112 intercepts fluid that is flung out from the gear 106. In other words, a portion of the fluid that is flung from the gear 106 impacts the L-shaped baffle 112 which then collects and re-directs that fluid under the influence of gravity to the bottom inside surface of the transmission housing. In this manner, the baffle 112 efficiently acts to enable a sufficient supply of fluid to collect at the bottom inside surface of the transmission housing to adequately supply the demand for fluid at the pump inlet 108. This improves the cooling performance of the system even when the transmission is operated at high speeds, improves the ability of the system to transfer heat between the transmission and other components with a vehicle propulsion system, and reduces pump noise may as a result of elimination and/or reduction in fluid cavitation and air entrainment within the fluid at the inlet to the pump.

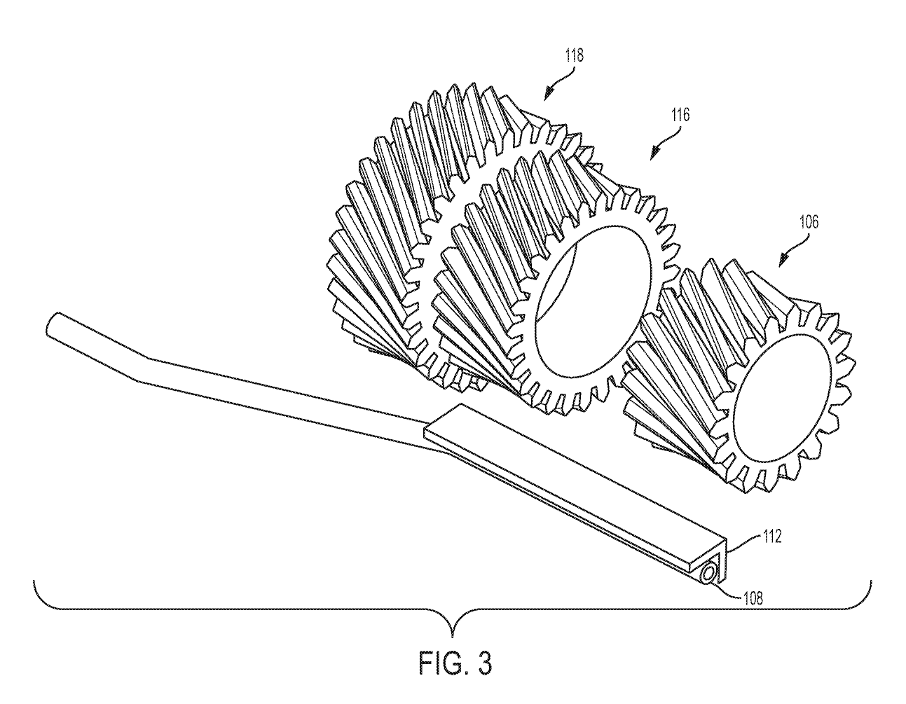

FIG. 3 is a perspective view of selected components from the manual transmission 100. In particular, FIG. 3 illustrates a perspective view of the relative positioning and orientation of the gear 106, the L-shaped baffle 112, and the pump inlet 108. FIG. 3 also illustrates additional gears 116 and 118 which, like gear 106, are co-axially mounted on the same counter shaft (not shown) and are distributed longitudinally along the axis of the counter shaft relative to each other. The L-shaped baffle 112 has a longitudinal extent which is sufficient to be positioned between each of the gears 108, 116, and 118, and the inlet 108.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A vehicle propulsion system, the system comprising:
a manual transmission including a transmission housing;
a pump inlet positioned near an inside bottom surface of the transmission housing; and
a baffle positioned adjacent the pump inlet for directing lubricating fluid in the transmission toward the pump inlet.

2. The system of claim 1, wherein the shape of the inside bottom surface of the transmission is substantially horizontal and flat.

3. The system of claim 1, wherein a cross-section of the baffle is substantially L-shaped.

4. The system of claim 3, wherein the pump inlet s positioned on an interior of the L-shaped baffle.

5. The system of claim 3, wherein the baffle is positioned between the pump inlet and a gear of the manual transmission.

6. The system of claim 3, wherein the corner of the L-shaped baffle points toward a gear of the manual transmission.

7. The system of claim 3, wherein the pump inlet is substantially enclosed within the L-shaped baffle.

8. The system of claim 1, further comprising a filter at the pump inlet.

9. The system of claim 1, wherein the transmission housing is a non-sump transmission housing.

10. The system of claim 1, wherein the transmission housing is sump-less.

11. A manual transmission for a vehicle propulsion system, the manual transmission comprising:
a transmission housing;
a pump inlet positioned near an inside bottom surface of the transmission housing; and
a baffle positioned adjacent the pump inlet for directing lubricating fluid in the transmission toward the pump inlet.

12. The transmission of claim 11, wherein the shape of the inside bottom surface of the transmission is substantially horizontal and flat.

13. The transmission of claim 11, wherein a cross-section of the baffle is substantially L-shaped.

14. The transmission of claim 13, wherein the pump inlet is positioned on an interior of the L-shaped baffle.

15. The transmission of claim 13, wherein the baffle is positioned between the pump inlet and a gear of the manual transmission.

16. The transmission of claim 13, wherein the corner of the L-shaped baffle points toward a gear of the manual transmission.

17. The transmission of claim 13, wherein the pump inlet is substantially enclosed within the L-shaped baffle.

18. The transmission of claim 11, further comprising a filter at the pump inlet.

19. The transmission of claim 11, wherein the transmission housing is a non-sump transmission housing.

20. The transmission of claim 11, wherein the transmission housing is sump-less.
